(19) United States
(12) Patent Application Publication
(10) Pub. No.: US 2003/0172512 A1
(43) Pub. Date: Sep. 18, 2003

(54) Process for manufacturing fuel tanks by blast shaping of steel

(76) Inventor: Carlos Infanzon Suarez, Pulianas (ES)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/208,734

(22) Filed: Jul. 30, 2002

(30) Foreign Application Priority Data
Mar. 12, 2002 (ES) 200200589

(51) Int. Cl. B23P 17/00; B23P 13/04

(52) U.S. Cl. 29/421.1; 29/557

(57) ABSTRACT

A process for manufacturing fuel tanks by blast shaping of steel is described, preferably stainless steel and occasionally, another type of carbon steel, especially for the type of fuel tanks to be assembled in automobiles, with any simple or complex, reinforced shape and with a wall thicknesses permitting up to a 50% weight reduction with regard to conventional tanks. The process comprises the preparation of flat or not flat metallic pre-forms, with identical or different dimensions, able to be eventually subjected to pre-heating, in order to then be placed into a mold which has the impression which is desired to be transferred, and to be subjected to a blast shaping operation with the use of a suitable fluid (liquid, gas or mixture of both), with the eventual application of intermediate heating operations where applicable.

### OBJECT OF THE INVENTION

The present invention refers to a process for manufacturing fuel tanks by blast shaping of steel, be it either stainless steel or carbon steel, which provides essential novelty features and significant advantages with respect to the known and used processes for these same purposes.

More specifically, the invention proposes a process by means of which it is possible to manufacture fluid storage tanks, especially, although not exclusively, of stainless steel, with the use of two identical (or alternately different) previously shaped metal plates, which are welded in their profile together with a tubing, and which are subsequently subjected to expander pressure within molds specially designed for this purpose (blast shaping operation by means of applying pressure, a process which can be performed in one or several steps, with or without pre-heating). The tank can thereby be made to have any physical shape which may be needed for adapting it to the necessities set as ideal for the design of the rest of the equipment in which it is to be included, as complex as it may be, it being possible to correspond even with designs in which the perimetral union of the two plates is not contained on the same plane.

Furthermore, the process of the invention also allows taking advantage of the hardening capacity of the materials upon being deformed, especially any type of steel, and more particularly stainless steel, due to which, for the same specifications, tanks can be made with considerably less thicknesses than those currently known and used.

The field of application of the invention is comprised within the industrial sector dedicated to manufacturing metallic tanks in general, and more specifically, tanks intended for the automobile sector, as for example fuel tanks.

### BACKGROUND OF THE INVENTION

It is generally known that the currently existing deposits, especially those intended for the automobile sector, are habitually constructed from plastic materials due to the low weight that they have, as well as with carbon steel. In the latter case, such deposits are made by means of a cutting-pressing and subsequent welding process of the two previously obtained semi-bodies, which normally limits the shape of them due to the necessity of maintaining a symmetry, and they must almost always have a plane where the two plates are joined.

Due to the environmental problems caused by the emissions existing in the case of using plastic tanks in the automobile, US legislation has recently started to apply standards eliminating the possibility of using this material, its metallic construction being a necessary requirement. However, the designs currently required by the manufacturers are easily complied with by the plastic models, and not by the metallic solutions.

On the other hand, the weight of metallic deposits is several times greater than that of the plastic ones, which constitutes a drawback regarding total weight reduction of the vehicle with the intention of a corresponding consumption reduction, and therefore in contamination. Furthermore, carbon steel tanks need to be finished with a paint protection, which also means a negative environmental impact in both its manufacturing and recycling.

In the specific case of tanks intended to be used as fuel containing deposits in vehicles, it is also necessary that they comply with certain requirements related to active and passive resistance, and which are detailed below:

Active Resistance: It is necessary that they have sufficient stiffness to withstand the fuel weight, as well as the effects of the forces generated by accelerations produced in all the axles. In this sense, stainless steel advantageously treated according to the process of the invention as proposed below, meets the concept of a lightweight material, since the specific stiffness (Young module divided by the density) reaches the value of 256 Pa/Kg/cm3, like that of aluminum, and furthermore, the specific strength (yield stress divided by the density) is larger (111.4 N/mm2: Kg/cm3 instead of 101.8 for aluminum).

Passive Resistance: Equally important or more important than active resistance, it is the capacity of being resistant to impacts generated in an accident. In this sense, the features of the stainless steel material subjected to the blast shaping process described below, and which generates the consequent hardening, are the most suitable upon reaching specific absorbed energy values of 38 Jules/gr (absorbed energy J/m3: density gr/cm3), whereas aluminum has 20.4 J/gr and high resistance carbon steel (12.5 J/gr).

Some attempts are known for providing solutions permitting the use of steel, and in this sense hydroforming processes have been developed which permit making more complex pressed shapes than those obtained by means of the conventional pressings, but in spite of this, they are limited to simple shapes due to cold working, and in all cases, to deformations as from a flat surface.

Spanish patent numbers ES-9801712 and ES-200001076 constitute examples of preparing steel containers with predetermined shapes with the use molds designed for this purpose, and whose final shape is obtained with the use of fluid-forming techniques.

For packaging and transporting some beverages, there are current manufacturing processes for plastic containers, such as the P.E.T. bottles manufacturing, which, as from a reduced dimension pre-form, permit subsequently blowing said pre-form very close to the place of use in order to obtain the definitive shape with a volume of up to 50 times bigger than the initial one. This process has the advantage of permitting considerably reducing transport costs due the comparatively small volume the pre-form has in comparison to the finished package. Furthermore, this process also constitutes an important advance in comparison to the ancient glass container manufacturing technique.

The present invention has been developed as from an idea equivalent to the already known technique in the P.E.T. case of preparing a pre-form to be subsequently treated until obtaining the definitive package, and has developed operative techniques which permit obtaining a previous product (or pre-form) from a metallic material such as stainless steel or another type of steel, which can be subsequently blown by means of applying a suitable pressure in the same place or in any other different place and far from the place where the pre-forms were made, providing solutions which permit resolving the technical difficulties of its industrial application, in order to provide the final product with the ideal features of cold deformed steel, in its case combining hot and cold deformation in a completely defined manner.

The process also foresees the subsequent placement of any element such as, for example, the different tubings.

As can be understood, the process itself constitutes an evident novelty within its specific field of application, since the formation of multiple shaped tanks can be obtained, as complex as those obtained when using plastic materials, and with higher passive and active resistance features for the same weight than with any other type of metallic material, at the same time also reducing the environmental impacts in the case of using a stainless material.

A tank manufactured by means of applying the process of the invention, regardless of the required dimensions or the intended use, thus has numerous advantages which, in the case of being constructed from steel material, is especially applicable to fuel deposits for the automobile, said advantages can be resumed as follows:

Possibility of extremely complex shapes adapted to the available space in the place of the vehicle reserved for the tank assembly;

Important weight reduction which can reach up to 50% with regards to those made with conventional processes;

100% recycling possibility;

No emissions, contrary to what occurs with plastic tanks, which ensures complying with any worldwide standard on environmental emissions, and

Possibility of complying with the re-using standard, since, by means of a new pickling and control process, it is possible to exactly obtain the original product conditions, provided that the during the prior use of the tank, no deformation occurred in it due to subjecting it to abnormal using conditions such as impacts, fire, etc.

### BRIEF DESCRIPTION OF THE DRAWINGS

These and other features and advantages of the process of the invention will become more clearly evident from the following detailed description of a preferred embodiment, given only as an illustrative and non-limiting example, taking into consideration the different phases shown in the attached drawings in which:

FIG. 1 shows schematic perspective views of the steps which comprise the necessary phases for making a pre-form;

FIG. 2 also schematically shows several views relating to the forming phases of the tank obtained by means of the process of the invention, as well as respective enlarged details relating to alternative dimensioning manners of the initial plates, and

FIG. 3 shows an example of a final complex tank obtained as a result of the process of the invention, and already provided with the necessary tubings for its assembly and application.

### DESCRIPTION OF A PREFERRED EMBODIMENT

As previously explained, the detailed description of the different phases of the process of the invention will be carried out with the aid of the attached drawings in which the same numerical references are used to designate the same or similar parts.

As explained before, the process of the invention is basically intended for the construction of a tank with the particular application to be used as fuel containers in an automobile, and it is obtained from two preferably but not necessarily flat, backing plates previously formed with the suitable profile, perimetrically welded together, and then the space comprised between the adjacent surfaces of both plates is “blown up”, be it in either hot or cold or even at a variable temperature by zones, in order to obtain the foreseen volume and shape provided by the mold used with the ideal mechanical properties on each point.

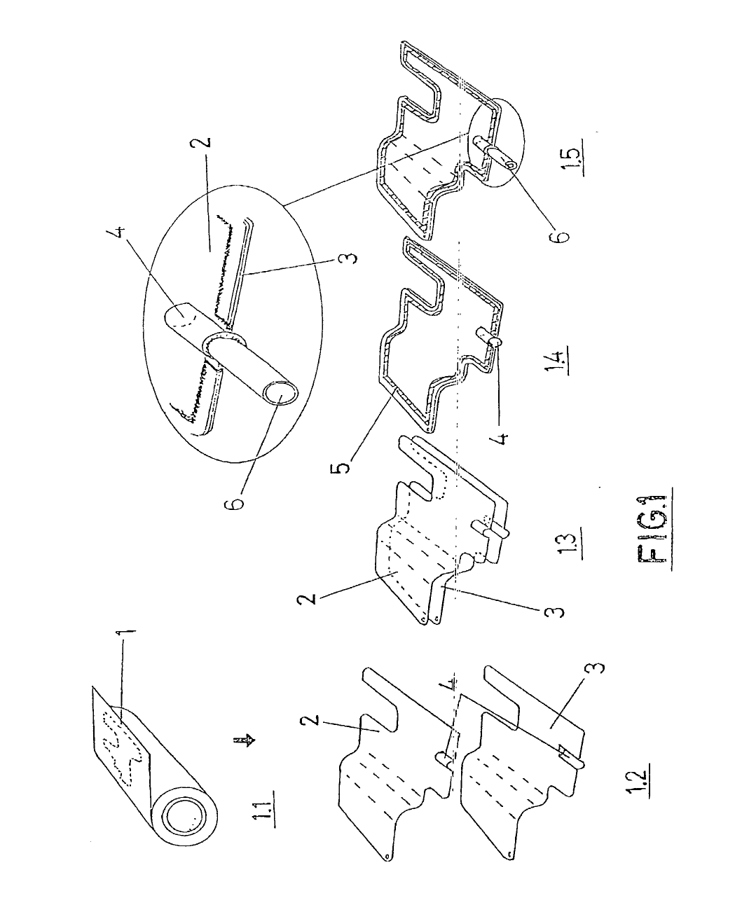

Making reference to the drawings appearing in FIG. 1, a series of steps intended for obtaining a steel pre-form can be seen, which in various successive steps will be subsequently subjected to said blast shaping operation by means of applying a fluid by pressure, in order to provide it with the shapes corresponding to the final required tank shape. By looking at this figure, it can be seen that each one of the phases has been numbered with the use of references derived from the figure number, namely, such as numbers 1.1. to 1.5, also showing an enlarged detail Dl of the latter. As can be seen, reference 1.1. shows the steel plate coil 1 as from which the two necessary plates for making the tank are obtained by means of some dying, cutting or any other suitable operation, as the pre-marking appearing on the plate surface shows. In a first preferred embodiment, the two suitably profiled plates are clearly equal to each other and are subjected to a pressing operation for the purpose of providing a recessed zone 4 on each one of them, symmetrical in relation to the medium plane (step 1.2), these recessed parts being intended to receive a tube by means of which the blowing fluid is subsequently injected. Next, step 1.3 shows the superimposition of both previously obtained plates 2, 3, for the purpose of being able to apply to them some mutual bonding operation providing a suitable seal, for example, by means of tacking and subsequent welding (wheels, TIG, laser, . . . ) as indicated by the dotted lines 5, or even on the very edge, according to that desired. If required, this operation may also be performed by seaming, in which case the mold must be designed accordingly.

As shown in step 1.4, the pressed parts 4 of both plates 2, 3 are now facing, thus providing a housing for a portion of a tube 6 which orthogonally protrudes from the edge of the two plate assembly. Once said tube 6 portion has been introduced in the housing provided by both pressed areas, it is then fixed in its position by means of a welding operation, which also ensures the sealing between the different elements.

Preferably, the tubing 6 is only applicable for the subsequent tank blast shaping operation. This fact, however, should not be understood as limiting, since said tubular element could be incorporated in a different area, particularly taking advantage of some of the tank openings which subsequently must fulfill some specific function during its use. In that case, the mold has to be suitably designed.

As previously stated, steps 1.1. to 1.5 provide a fuel tank pre-form which can subsequently be used for formation of the definitive tank by means of blast shaping. In these conditions, however, it occupies a minimum space, providing the additional advantage of easier storage until its final blast shaping, and also permitting a transport cost reduction in the case that the pre-form is to be sent to another place where the definitive tank will be formed.

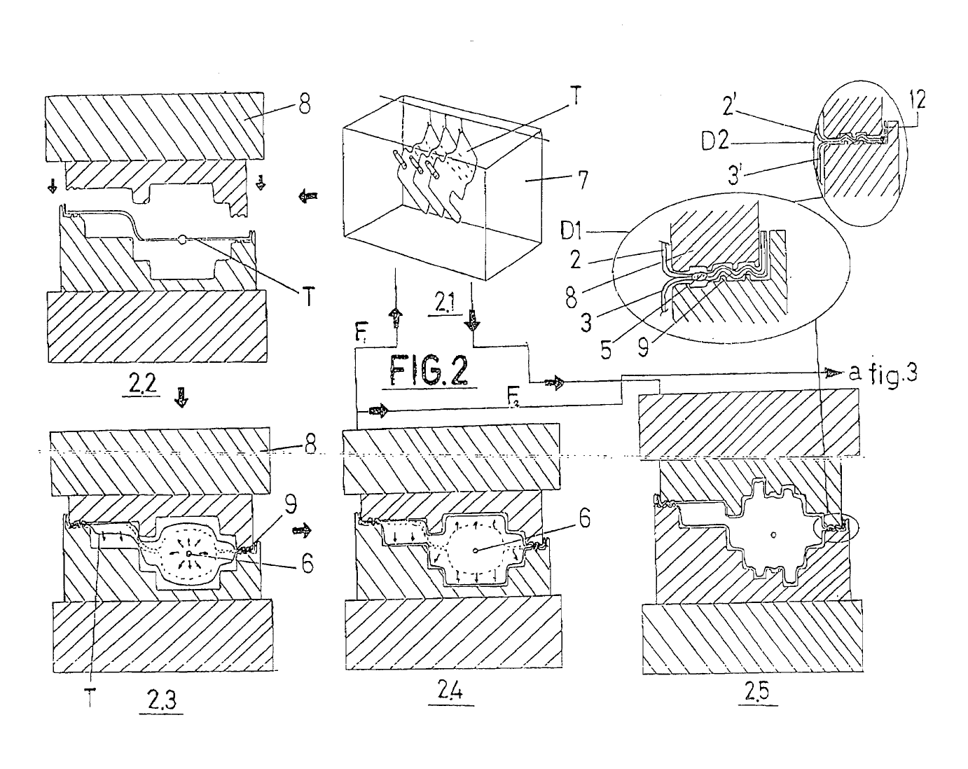

The subsequent tank forming operations as from the pre-form obtained in steps 1.1 to 1.5 are shown in the different views of FIG. 2, which have been numbered as 2.1 to 2.5. A heating step 2.1 can first be seen, which schematically shows several assemblies “T” hung inside a conventional furnace 7. This situation shows the case in which uniform heating of the parts is carried out, which normally corresponds to the majority of the cases; however, depending on the final tank design, it may be necessary to apply a non uniform heating by areas to the assemblies “T” with the use of induction furnaces, and such that the selected heating type will be such that it permits obtaining, in all cases, the most complex shapes and the suitable thicknesses ensuring the required resistance in the different tank areas.

As can be understood, the temperature applied to the assemblies “T” inside the furnace 7 will be suitable for ensuring the required finish as per the specific project, with the particularity being that if the heating corresponds to an operation after the blast shaping, said temperature will normally be higher than the annealing temperature.

The former corresponds to the case in which the “T” pre-forms are to be subjected to one or more heatings. However, depending on the foreseen deformations, such heating may not be necessary since, as skilled persons in the art know, the case of stainless steel in cold has elongations of up to 55%, it being possible to place hot or cold inside the mold, as corresponds in each case.

Following step 2.1, the assemblies “T” pass to steps 2.2, 2.3, 2.4 in which a mold 8, where the impression corresponding to the required tank forms has been previously engraved, such that once the mold is closed (steps 2.3 and 2.4), the fluid is applied by pressure through the tubing 6 once the “T” assembly has been fixed by pressure of both parts of the mold on a perimetral band 9 of it. The fluid injected by pressure through the tubing 6 causes an assembly deformation by blast, such that it progressively adapts it to the general shape provided by the inside cavity of the mold 8, such as seen in steps 2.3 and 2.4.

As has been said, the “T” assembly is fixed in the blast shaping position due to the pressure exerted by the mold on the perimetral band 9. As can be understood, however, that band 9 can adopt different shapes, it could be flat or of any other shape corresponding to the calculations corresponding to the passive resistance it must have, including deformations, pressings, folds or any other, such as can be better seen in the schematic view of the enlarged detail D1 extracted from FIG. 2.5. Furthermore, the fact of holding the material by the inside band 9 to the weld 5 prevents the occurrence of shearing stresses in said area, generated by the blast shaping pressure. If necessary, the molds may have some temperature control system in the pressure area of the band 9, permitting optimizing the blast shaping and manufacturing process.

As can be understood, the emptying of the liquid can be performed by placing the mold with the tubing 11 in the suitable position, and such that the internal gas pressure can be used for removing the liquid.

The blast shaping or pressure application operation is carried out in one or several phases by means of a fluid such as a gas, a liquated gas, a liquid, etc. or any combination thereof which, enables obtaining a final cold deformation ensuring the material hardening process regardless of the initial temperature, which, as has been previously indicated and particularly when using stainless steel, increases the yield stress up to approximately 200%, which, for the same services, permits reducing the thickness of the tank walls (and therefore the weight) by up to 50%.

On the other hand, carrying out the blast shaping process proposed by the invention eliminates the need of carrying out very expensive pressing and hydroforming tools, and furthermore limited to not very complex surfaces, whereas with the process invention, practically any shape obtained with the plastics can be produced.

If the shape is very complicated, it may be necessary to perform the blast shaping in several steps, in which case intermediate annealing treatments may be needed, which permit making new elongations of the material without the risks of bursting. This situation is schematically shown by means of the arrows F1 and F2, which mark different paths for the part obtained in step 2.4, respectively directing it to the furnace of step 2.1 or directly to the process exit. Step 2.5 therefore constitutes an additional phase corresponding to blast shaping in several steps with intermediate heating, prior to obtaining the final tank. The process definition aims to obtain performing the necessary deformation in order to obtain the final shape, leaving the material in the final blast shaping phase with the maximum yield stress value, very close to the breaking stress and with low elongation, providing sufficient margin for an industrial process without rejections due to bursting.

The aforementioned operation allows obtaining the necessary and experimentally, or by any calculation method, defined product, adapted to the available space in the place of assembly, which will have the corresponding cavities, supports, anchoring areas, etc. necessary for meeting the specified active and passive resistance requirements.

As per the descriptions given up to this moment, it has been given as from the basis that both plates 2, 3 used for obtaining the pre-form are equal to each other. However, as already mentioned at the beginning of the description, the invention may equally be applied to the alternative case that both plates 2, 3 are designed with different sizes, as shown in the detail view D2 of said FIG. 2. In fact, in this alternative embodiment, both parts 2, 3 have been provided with different profiles such that one of them, plate 3′ for example, shows slightly larger dimensions than the other, plate 2′ for example, such that during the forming operation, the excess part of the larger plate 3′ can be folded for the purpose of forming a ridge 12 which aids in placing and centering the smaller sized plate 2′, as seen in said detail D2. Naturally, the remaining operations previously described for the case of two identical plates are perfectly applicable to this alternative embodiment. In this case, the welding occurs in the angle of said ridge 12.

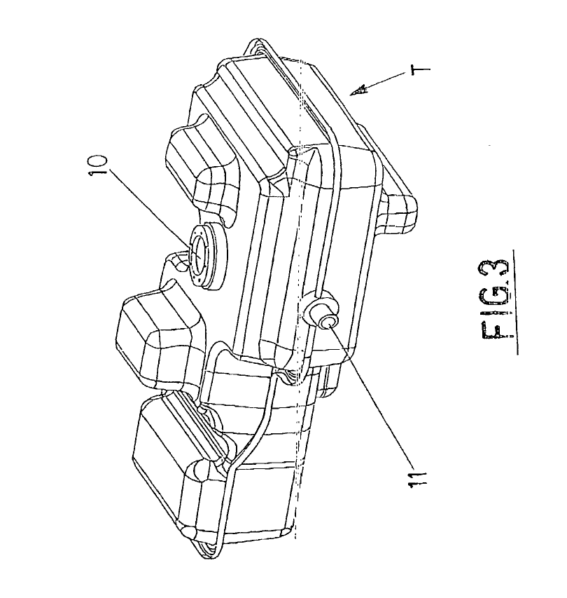

An embodiment example of a tank with complex shapes which can be obtained by means of the process of the invention can be seen in FIG. 3 of the drawings. This tank “T” obtained from the previously described successive steps is seen as finished once the fluid used for the blast shaping has been extracted and after having been suitably machined for forming the different orifices or accesses to the inside space, as well as being provided with the necessary external devices depending on the final intended application. In this sense, a tank is shown provided with an opening 10 on the upper part which, for example, could correspond to the opening for fuel filling in the case of a tank for a vehicle, and with a portion of an outer fuel outlet tube 11, which, although this tube is shown at an intermediate height in the Figure, it is understood that for an application of this type, it will be fixed at a much lower level, or in any other desired position. The finishing operations may also include the use of suitable cleaning and determined surface finishing means and processes, as well as controls of other types.

As a conclusion, the invention permits making recipients weighing less than the conventional ones for the same use requirements, making it possible to make low volume pre-forms which, for large quantities, are delivered as such pre-forms to the consumption areas, in order to be finished in facilities close to the final assembly site, performing the heating/blast shaping and assembly in these facilities, as well as final control. Furthermore, it permits obtaining forms which are even more complex than those obtained up to now by eliminating the limitation implied by requiring that the two plates have the edge on one plane.

Using stainless steel material obtains the drastic reduction of the tank's thickness and therefore the initial transport cost to the assembly place, but mainly for the road transport sector, the vehicle weight is reduced, that is to say less consumption and thus less contamination. Steel and especially stainless steel tanks also have the ecological advantage as they do not need to be painted, recycled 100% and the possibility of re-using at the end of the useful life of the vehicle.

In any case and as an additional advantage, it can also be seen that the process proposed by the invention enables all the inherent operations to be continuously and repetitively carried out with a high level of easiness and reliability, which, together with the aforementioned features, makes the obtained product highly competitive.

It is not considered necessary to extend the content of this description so that a skilled person in the art can understand its scope and the advantages derived from the invention, as well as to develop and put it into practice.

However, it must be understood that the invention has been described according to a preferred embodiment thereof, and thus can be modified without altering the basic scope of said invention, such modifications may especially affect the shape, size and/or materials used in the described manufacturing process, as well as the conditions under which the process is developed.

1.- Process for manufacturing fuel tanks by blast shaping of steel, for obtaining tanks preferably applicable to their assembly in motor vehicles under advantageous conditions of increased active and passive resistance, characterized in that it essentially comprises steps for:
a) preparing a pre-form from the metallic material used, especially some type of steel;
b) eventually subjecting the pre-form to a pre-heating;
c) placing the hot or cold pre-form, as convenient, inside a mold especially prepared for this purpose, which includes the impression corresponding to the required tank shape to be obtained;
d) applying a blast shaping fluid to the pre-form inside the mold, for the purpose of blowing the pre-form so that in one or several phases, it adapts to the foreseen shape in the impression of the mold;
e) subjecting the partially shaped pre-form to possible intermediate heatings, where applicable;
f) extracting the blast shaping fluid, and
g) machining the obtained complex tank in order to provide it with the necessary external connections and openings for its correct use depending on its final foreseen application.

2.- Process according to claim 1, characterized in that making the pre-form foreseen in step a) includes obtaining two flat or not flat metallic plates (2, 3; 2′, 3′) suitably formed and profiled in accordance with the foreseen final tank design, to which a pressing operation is applied for shaping a respective recessed zone (4) next to the edge of each plate, in correspondingly facing positions, after which both plates (2, 3; 2′, 3′) are hermetically locked together by applying a perimetral welding line (5), as well as introducing a portion of a tube (6) into the housing provided by said facing pressings (4) of both metallic plates (2,3), fixing said tube portion (6) to both metal plates by welding or similar.

3.- Process according to claim 1, characterized in that the eventual heating operation of the obtained pre-forms (“T”) foreseen in step b) is carried out inside a conventional furnace (7) in the case of uniform heating, or inside induction furnaces in the case that the applied heating should not be uniform or varies from one zone to another.

4.- Process according to claim 1, characterized in that the pre-forms placement operation described in step c) inside the shaping molds (8) containing the impression corresponding to the required tank to be obtained is carried out such that a perimetral band (9) of the pre-form is located on the pressure area of the mold, such that said pressure area is preferably located inside the perimetral weld (5) of the pre-form, and it can also be flat or have any kind of regular profile or not.

5.- Process according to claim 1, characterized in that the blast shaping operation of the pre-form described in step d) is carried out once both parts of the mold (8) have been closed, with the pre-form held by the pressing force of the pressure area of the mold on said perimetral band (9), and applying a blast shaping fluid through the pre-form tubing (6).

6.- Process according to claim 5, characterized in that the used blast shaping fluid consists of a gas, a liquated gas, a liquid or a combination thereof.

7.- Process according to one or more of the previous claims, characterized in that the last blast shaping operation includes performing a cold deformation which determines an increase in the yield stress and breaking stress, thus permitting a tank design including complex shapes with ribs, supports or others, and such that with the suitable combination of heating/blast shaping operations, tanks with less wall thickness and consequently of reduced weight can be designed.

8.- Process according to claim 7, characterized in that the different heating/blast shaping operations permit obtaining metallic tanks, of steel hardened during the process, with any shape which permits an adaptation to the shape of the available space, with weight reductions of up to 50% compared to conventional deposits.

9.- Process according to one or more of the previous claims, characterized in that the performance of step a) for the previous obtaining of the pre-forms enables transporting them to another distant place, where they can be subjected to the remaining necessary steps for forming the tank with the final required shape and features.

10.- Process according to claim 1, characterized in that in one embodiment, the plates (2, 3) are identical.

11.- Process according to claim 1, characterized in that in an alternative embodiment, the plates (2′, 3′) are of different size, and in that the bigger plate (3′) can be shaped such that the excess perimetral part in relation to the plate (2′) of smaller dimensions can be folded to form a ridge which aids in placing and centering the smaller one with respect to the bigger one.

12.- Process according to one or more of the previous claims, characterized in that the longitudinal development of the perimetral fixing and sealing zone of both plates (2, 3) constituting the pre-form may be contained on the same plane or have level variations.
